(19) United States
(12) Patent Application Publication
(10) Pub. No.: US 2026/0046727 A1
(43) Pub. Date: Feb. 12, 2026

(54) CONFIGURATION OF UE CONTEXT SURVIVING DURING AI/ML OPERATION

(71) Applicant: Nokia Technologies Oy, Espoo (FI)

(72) Inventors: Anna PANTELIDOU, Antony (FR); Hakon HELMERS, Sceaux (FR); Ethiraj ALWAR, Bangalore (IN)

(21) Appl. No.: 19/099,686

(22) PCT Filed: Jun. 15, 2023
(86) PCT No.: PCT/EP2023/066034

§ 371 Date: Jan. 29, 2025

(30) Foreign Application Priority Data
Aug. 5, 2022 (IN) 202241044897

(51) Int. Cl. H04W 36/20; H04L 41/16

(52) U.S. Cl. CPC H04W 36/20; H04L 41/16

(57) ABSTRACT

It is provided an apparatus comprising one or more processors and a memory storing instructions that, when executed 2024/027980 by the one or more processors, cause the apparatus to: submit, by a source network entity of a RAN, a request to a target network entity, the request including at least a user equipment machine learning, UE ML, group index, wherein the UE ML group index indicates that an UE is part of an UE ML group; receiving, by the source network entity, a response message from the target network entity based at least on the indicated UE ML group index.

### TECHNOLOGY

The present disclosure relates to a method and a system for improving user equipment, UE context management in relation to optimized handover procedure and more particularly for maintaining Artificial Intelligence, AI, Machine Learning, ML, contexts in a radio access network, RAN, between at least a source network entity and a target network entity such as two Next Generation NodeBs, gNB.

### BACKGROUND

Any discussion of the background art throughout the specification should in no way be considered as an admission that such art is widely known or forms part of common general knowledge in the field.

The emergence of the fifth-generation technology standard (5G) for broadband cellular networks has driven the need to study new use cases and to propose potential service requirements for 5G systems to equally support AI/ML usage for service enhancements.

On that account, a new SI RP-201620 “Study on enhancement for data collection for NR and EN-DC” started in RAN3 #110e which set the objective to specifically study high level principles for the enablement of AI in RAN and the functional framework including the AI functionality and the inputs and outputs needed by the ML algorithm to herewith achieve high precision outputs and possible feedback optimization in 5G systems. Specifically, the SI aimed to identify the data needed by an AI function in an input and the data that is produced in an output as well as standardization impacts at a node in the existing architecture or in the network interfaces to transfer the aforementioned input/output data through them.

Based on this, in 3GPP TR 37.817, varying solutions have been then proposed to initially realize AI/ML implementation in RAN. In those solutions, generally different network interfaces are introduced in which at least the “Input Data for Training” (Training Data), “Input Data for Inference” (Inference Data), Output Information after a ML Decision is made and a required Feedback to capture the effect of the respective ML model are to be generated, leading to an at least functional framework concept for AI/ML usage in RAN.

However, despite the current efforts to improve the preciseness and stability of present RAN implemented ML models, there is still the problem that due to the dynamic and distributed architecture of RANs (and thus the requirement of a source gNB to request and obtain training or measurement data from other (target) gNB nodes), essential information for at least enabling entity specific AI/ML model outputs or, generally, inter-node based RAN actions can be lost, resulting in a substantial diminishment of the efficiency of the respective RAN procedure.

For example, one method for receiving neighboring node information is utilizing the resource status procedure. However, resource status information does not include any further specifications pertaining e.g. the single UEs the requested data is gained from, leading to the fact that in current RAN architecture signaling, there is no method to collect UE (or UE group) specific information from neighbor nodes, not to mention to store this information for use after the UE context has been released.

Thus, there is a need to propose a new method and apparatus for a RAN based feedback system, particularly a RAN based AI/ML model system, that addresses some or all of the above-stated problems in an efficient, flexible and yet reliable manner.

### SUMMARY

According to some aspects, there is provided the subject-matter of the independent claims. Some further aspects are defined in the dependent claims.

In accordance with a first aspect of the present disclosure, there is provided at least a first apparatus comprising:
one or more processors; and
a memory storing instructions that, when executed by the one or more processors, cause the first apparatus to:
submit, by a source network entity of a radio access network, RAN, a request to a target network entity, the request including at least a user equipment machine learning, UE ML, group index, wherein the UE ML group index indicates that a UE is part of a UE ML group; and/or
receive, by the source network entity, a response message from the target network entity based at least on the indicated UE ML group index.

Herein, in some examples, the respective target network entity and the source network entity may be connected via RAN. Further, at least the source network entity may be a first NG-RAN node while the target network entity may be a second NG-RAN node connected to the source network entity or an Operations Administration and Maintenance, OAM, leading to the effect that by the above-mentioned instructions, an inter-node signaling operation in RAN pertaining to the exchange of UE specific information and thus of potential UE ML contexts may be generated.

Further, in some examples, the above-mentioned request may include an ID for identifying a UE ML group and configuration information, wherein the ID is configured at least for one of the following: indicating requested data to be collected by the target network entity or indicating collected data by the target network entity required for training and/or inference of a machine learning, ML model.

Accordingly, by the above-mentioned ID, measurement data required for AI ML model usage in RAN can be initially specified, leading to a faster and resource-saving uptake of the respectively stored measurement data from the requested UEs or the target network entity. As a consequence, in some examples, the target network entity may be configured to enquire and receive only ID specific measurement data from predefined UEs or the target network entity may be configured to enquire and receive all measurement data from predefined UEs and subsequently filter out only ID specific measurement data. Equally, the source network entity may be configured to request and receive the respective collected measurement data from the target network entity based on the correspondingly chosen ID, leading to a selective and efficient aggregation of required information by calculating performance information corresponding to a certain ID which can be useful e.g., for implemented AI ML model training at the source network entity.

In a preferred example of the disclosure the UE ML group is set in advance of a handover procedure and preferably only available/accessible between network nodes during inter node signaling. The UE ML group may characterize the UEs of common inference action to provide feedback information, even after the handover is completed, wherein inference action may only be a subset. UE ML group may indicate a set of UEs receiving similar handling in the RAN due to e.g. UE history or following a similar mobility path or trajectory, radio capabilities, activated services or slices, radio conditions, UEs impacted by a network action (e.g., by a SON or AI/ML algorithm output or some other network decision), etc.

Herein, in some examples, the collected measurement data from UE may correspond to outputs and parameters of non-limited UE measurements, for example UE measurements related to RSRP, RSRQ, SINR of serving or neighboring cells of the respective UE. Alternatively, measurements (and thus usable measurement output data) may also comprise data generated during inference from a target or source network entity or from a UE, at least when AI ML decisions are taken. Further, measurements and measurement data may also comprise performance information on UE-level (e.g. bit-rate, packet loss, latency, energy efficiency etc.) over UEs impacted by at least an inference action, wherein inference actions may be for example at least a Handover trigger for a UE due to AI ML optimization decisions such as mobility optimization decisions or a switch off of UEs connected to a capacity cell for energy saving purposes or load balancing purposes, to mention a few examples. Further alternatively, measurement data may also comprise performance information at cell-level after an inference action is taken, wherein said inference actions may be based on a number of system Key Performance Indicators (KPI) such as throughput, delay, Radio Link Failure (RLF), counters, etc.)

Additionally, in some examples, the configuration information may further include an instruction how the requested data should be collected, wherein the requested data may include at least one of: requested measurements, requested counters or requested predictions. This requested data may preferably include feedback information introduced for different use cases, such as: for an energy saving us case: resource status of neighboring NG-RAN nodes, energy efficiency, UE performance affected by the energy saving action (e.g., handed-over Ues), including bitrate, packet loss, latency; system KPIs (e.g., throughput, delay, RLF of current and neighboring NG-RAN node); for a load balancing use case: UE performance information from target NG-RAN (for those Ues handed over from the source NG-RAN node), resource status information updates from target NG-RAN, system KPIs (e.g., throughput, delay, RLF of current and neighbors), ; for a mobility optimization use case: QoS parameters such as throughput, packet delay of the handed-over UE, etc., resource status information updates from target NG-RAN, and/or performance information from target NG-RAN. Further, in some examples, the feedback information may include timing information such as at least information which are averaged over a period of time. Herein, feedback information may for example include for example data with respect to a throughput of the RAN or a delay metric which are metrics averaged over a period of time after a Handover is completed at the target network entity, a hence the UE context has ceased to exist. Further, the feedback information may likewise include information of the period of time, exemplarily the timing window over which the average is calculated or a starting time of when a respective measurement needs to be calculated. Additionally or optionally, instead of a starting time, also a starting event, e.g. when a first UE in a UE ML group is handed over, can be comprised. All or part of these time related information may be included in an instruction specifying timing information of the requested data.

In some examples, the first apparatus is further caused to: train and/or execute the ML model at least based on the received response message of the target network entity. Consequently, in a respective example of the disclosure both, AI ML Model Training and/or Model Inference may be conducted based on UE ML group index specific data implementations. Further, since output of the AI ML model remains equally dependent on the feeded data determined by the implemented UE ML group index, following RAN signaling procedures, such as Feedback Reports or iterative Feedback Loops for AI ML model adjustments may be likewise dependent on the UE ML group index selection.

As a consequence, in some examples, the response message may be equally a feedback report provided after an ML model inference is executed, in a use case including a UE handover.

In some examples the apparatus is caused to execute a UE handover procedure according to an optimization action based at least on information according to the received response message. The optimization action may be a result of an optimization using an optimization algorithm such as an AI/ML model inference and the use cases covered may include energy saving, load balancing and/or mobility optimization. Further details of the use cases can be found in TR37.817 which is herewith incorporated by reference.

Additionally, in some examples, the response message may include a UE ML group index and feedback information, wherein the feedback information may further include information of UEs impacted by an ML inference.

In some examples, a UE ML group index yet also may contain information about predefined network action. For example, a UE ML group index may contain information regarding the network action for which the UE ML group index was created, leading to additional parameters usable for the inter-node signaling in RAN. Exemplarily, a UE ML group index may indicate the purpose (e.g., energy saving, load balancing, mobility enhancement etc.) of the AI ML model the collected measurement data is used for. In other examples, the UE ML group index may also include information concerning the predefined criterion that created the UE ML group index, wherein the information may be readable by at least one of the following source network entity or target network entity.

Accordingly, in some examples, said period of time may include at least a time and/or event after a handover or handover process is completed at the target network entity.

For this, at least one of the source network entity or the target network entity may be configured to locally store information about at least one UE ML group in a UE ML group context. In it, the group context may for example be the UE ML group index so that each of the respective target network entity and/or source network entity may provide UE ML group context information. Further, at least one of the source network entity or the target network entity may be configured to indicate that the UE ML group context shall survive (at least a predefined or variable time) after a UE Context Release is sent from the target network entity to the source network entity.

As a consequence, in some examples, the first apparatus is further caused to: indicate, by the source network entity, that the UE ML group index will remain after at least receiving the response message from the target network entity.

In some examples, the feedback information may be logged in a ML Report that accumulates the requested data from a neighboring network entity.

In some examples, the UE ML group index may allocate a UE to a UE ML group based on at least a predefined criterion, wherein the UE ML group may correspond to a set of UEs receiving similar handling in the network. In some examples, the predefined criterion may be defined by at least one of the following: all UEs considered by the ML model, UEs having same or similar UE history or following a similar mobility path or trajectory in the RAN, radio capabilities, activated services or slices, radio conditions, all UEs whose RSRP values are below a threshold or all UEs whose RSRP values are above a threshold, UEs impacted by a network action that is based on ML decision or output, UEs associated to a network entity, UEs connected to a certain beam index or cell ID of a distributed unit (DU) or belonging to a defined area.

In some examples the request to the target network entity requests information per UE ML group. Moreover, the response message from the target network may provide information per UE ML group.

In some examples, the first apparatus may be further configured to send a configuration message to at least one UE including configuration information for initiating a predefined UE measurement and to receive a measurement report message from the at least one UE including the output of the predefined UE measurement.

Alternatively, in accordance with a second aspect of the present disclosure, there also may be provided a second apparatus comprising:
one or more processors; and
at least a memory storing instructions that, when executed by the one or more processors, cause the apparatus to:
transmit, by a source network entity, to a target network entity of a RAN, a handover request message including a UE ML group index, feedback configuration information and an instruction that feedback information should be available after the handover is completed for the UE and/or available after a context release message is sent from the target network entity to the source network entity;
receive, by the source network entity, a response message from the target network entity based at least on the indicated UE ML group index and including the feedback information.

Moreover, alternatively or additionally, the apparatus may be caused to transmit, by a source network entity to a target network entity, a handover request message including a user equipment machine learning, UE ML, group index and an instruction that feedback information should be available after the handover is completed for the UE, or available after a context release message is sent from the target network entity to the source network entity. Context release message can be sent from the target network entity to the source network entity at a time after the (average) performance information (e.g., throughput, delay, QoS, etc.) is calculated. Context release can be indicated by the target network entity to the source when it sends feedback information back to the source network entity. A source network entity can interpret an indication to release context when it receives feedback information from the target network entity corresponding to a specific AI ML context. Context release can be triggered also independently by the source node when it doesn't any more need to maintain the specific AI ML context corresponding to UE ML group with the target network entity or when an internal timer expires. Context release message can be sent much later in time after a handover is executed and after the UE context of a handover operation has ceased to exist. Moreover, the source network entity may be configured to store the information of the handover required message at least until a release message (preferably a context release message e.g., sent from the target network entity) is received at the source network entity. Moreover, the apparatus may further be caused to receive, by the source network entity, a response message from the target network entity based at least on the indicated UE ML group index and including the feedback information; and to execute a UE handover procedure according to an optimization action based at least on the feedback information of the received response message.

In a further development an apparatus is suggested that receives, as a target network entity, a handover required message including a user equipment machine learning, UE ML, group index and an instruction that feedback information should be available after the handover is completed for the UE, or available after a context release message is sent from the target network entity to the source network entity. The target network entity may preferably be further configured to transmit to the source network entity, a response message based at least on the indicated UE ML group index and including the feedback information; and to execute a UE handover procedure according to an AI/ML optimization action (or alternatively a non AI/ML optimization action, and therefore an optimization based on an non-AI optimization algorithm) based at least on the feedback information of the received response message. The feedback information (in case of an AI/ML optimization application) may further be used as input data for training such as training data and/or input data for inference such as inference data.

Further, in accordance with a third aspect of the present disclosure, there may be likewise provided a third apparatus comprising:
one or more processors; and
at least a memory storing instructions that, when executed by the one or more processors, cause the third apparatus to:
receive, at a target network entity of a RAN, a request including at least a UE ML group index, wherein the UE MLgroup index may indicate that a UE is part of a UE ML group;
collect and locally store feedback information about UEs existing in UE ML groups of the target network entity, at least based on the UE ML group index; and
transmit a response message to the source network entity based on the indicated UE ML group index. In some examples, the aforementioned request may be a ML context initiation request including configuration information that indicate requested data to be collected by the target network entity or a feedback report request for information of UEs impacted by an ML inference.

In some examples, the response message may be a feedback report including information of UEs impacted by an ML inference and provided after an ML model inference is executed, in a use case including a UE handover.

Further, in accordance with a fourth aspect of the present disclosure, there may be likewise provided a fourth apparatus comprising:
one or more processors; and
at least a memory storing instructions that, when executed by the one or more processors, cause the fourth apparatus to:
transmit, by a target network entity of a RAN, a feedback report provided after an ML model action is executed, in a use case including a UE handover,
wherein the feedback report is transmitted when receiving a request from the source network entity or when the feedback report is available at the target network entity or at a predetermined time after the handover.

In accordance with yet another aspect of the present disclosure, there also may be provided a method of a first apparatus comprising at least one or more processors and a memory storing instructions, the method comprising:
submitting, by a source network entity of the first apparatus of a RAN, a request to a target network entity, the request including at least a UE ML group index, wherein the UE ML group index indicated that a UE is part of a UE ML group; and
receiving, by the source network entity, a response message from the target network entity based at least on the indicated UE ML group index.

In accordance with yet another aspect of the present disclosure, there also may be provided a method of a second apparatus comprising at least one or more processors and a memory storing instructions, the method comprising:
transmitting, by a source network entity of the second apparatus, to a target network entity of a RAN, a handover request message including a UE ML group index, feedback configuration information and an instruction that feedback information should be available after the handover is completed for the UE or available after a context release message is sent from the target network entity to the source network entity; and
receiving, by the source network entity, a response message from the target network entity based at least on the indicated UE ML group index and including the feedback information.

In accordance with yet another aspect of the present disclosure, there also may be provided a method of a third apparatus comprising at least one or more processors and a memory storing instructions, the method comprising:
receiving, at a network entity of the third apparatus of a RAN, a request including at least a UE ML group index, wherein the UE ML group index may indicate that a UE is part of a UE ML group;
collecting and locally store feedback information about UE existing UE ML groups of the target network entity at least based on the UE ML group index; and
transmitting a response message to the source network entity based on the indicated UE ML group index.

In accordance with yet another aspect of the present disclosure, there also may be provided a method of a fourth apparatus comprising at least one or more processors and a memory storing instructions, the method comprising:
transmitting, by a target network entity of the fourth apparatus of a RAN, a feedback report provided after an ML model action is executed, in a use case including a UE handover,
wherein the feedback report is transmitted when receiving a request from the source network entity or when the feedback report is available at the target network entity or at a predetermined time after the handover.

In some examples of at least one of the above-mentioned methods of the first to fourth apparatus, the feedback information may include at least information which are averaged over a period of time. Specifically, the period of time may include at least a time after a handover is completed at the target network entity. In a further advantageous development, the period of time may be defined in the ML context initiation request message and/or can be part of the measurement configuration.

In some examples of at least one of the above-mentioned methods of the first to fourth apparatus, the used feedback information may be logged in a ML Report that accumulates the requested data from a neighboring network entity.

In some examples of at least one of the above-mentioned methods of the first to fourth apparatus, the UE ML group index may allocate a UE to a UE ML group based on at least a predefined criterion, wherein the UE ML group may correspond to a set of UEs receiving similar handling in the network.

In some examples of at least one of the above-mentioned methods of the first to fourth apparatus, the predefined criterion may be defined by at least one of the following: all UEs considered by the ML model, UEs having same or similar UE history or following a similar mobility path or trajectory in the RAN, radio capabilities, activated services or slices, radio conditions, all UEs whose RSRP values are below a threshold or all UEs whose RSRP values are above a threshold, UEs impacted by a network action that is based on ML decision or output, UEs associated to a network entity, UEs connected to a certain beam index or cell ID of a distributed unit (DU) or belonging to a defined area.

In some examples of at least one of the above-mentioned methods of the first to fourth apparatus, the group index may include information concerning the predefined criterion that created the UE ML group index, wherein the information may be readable by at least one of the following source network entity or target network entity.

In some examples of at least one of the above-mentioned methods of the first to fourth apparatus, at least the method of the first or second apparatus may additionally comprise: storing, by the source network entity of the first or the second apparatus, the UE ML group index over a predetermined time, wherein the predetermined time is at least a time after a handover is completed at a target network entity. Moreover, preferably the UE ML group and/or index is valid only for feedback collection purpose and after the feedback is received and if no other feedback is pending, then it will not be valid or it may be deleted.

In some examples of at least one of the above-mentioned methods of the first to fourth apparatus, at least the method of the first or second apparatus may additionally comprise: indicating, by the source network entity of the first or second apparatus, that the UE ML group index will remain after at least receiving the response message from the target network entity. Moreover, preferably the UE ML group and/or UE ML group index is valid only for feedback collection purpose and after the feedback is received and if no other feedback is pending, then it will not be valid or it may be deleted.

In some examples of at least one of the above-mentioned methods of the first to fourth apparatus, at least the method of the first or second apparatus may additionally comprise: sending a configuration message to at least one UE including configuration information for initiating a predefined UE measurement and to receive a measurement report message from the at least one UE including the output of the predefined UE measurement.

In some examples of at least one of the above-mentioned methods of the first to fourth apparatus, the request received by the target network entity of at least the third or fourth apparatus may be a ML context initiation request including configuration information that indicate requested data to be collected by the target network entity or a feedback report request for information of UEs impacted by an ML inference. Moreover, in a further advantageous development the configuration information of the ML context initiation request, may further include timing information regarding when the measurement collection at the target will start, when it will stop and/or what measurements should be collected.

In some examples of at least one of the above-mentioned methods of the first to fourth apparatus, the response message transmitted by a target network entity to a source network entity may be a feedback report including information of UEs impacted by an ML inference and provided after an ML model inference is executed, in a use case including a UE handover.

Further, in accordance with a fifth aspect of the present disclosure, there may be likewise provided a network system, comprising:
at least one of the first or second apparatus; and
at least one of the third or fourth apparatus;
   wherein the at least one of the first or second apparatus and the at least one of the third or fourth apparatus are connected via RAN; and
the network system is configured to cause the at least one of the first or second apparatus and the at least one of the third or fourth apparatus to perform any of the aforementioned method steps.

Further, in accordance with a third aspect of the present disclosure, there may be likewise provided a third apparatus comprising:
one or more processors; and
at least a memory storing instructions that, when executed by the one or more processors, cause the third apparatus to:
receive, at a target network entity of a RAN, a request including at least a UE ML group index, wherein the UE ML group index may indicate that a UE is part of a UE ML group;
collect and locally store feedback information about UE existing UE ML groups of the target network entity at least based on the UE ML group index; and
transmit a response message to the source network entity based on the indicated UE ML group index.

Although reference is made to the UE ML group, UE ML group index and UE ML context, which may be characteristic for an AI/ML framework, in a further development, in case a non AI/ML algorithm is used, there may be a UE group (or UE optimization group) a UE group index (or UE optimization group index) and a UE context (or UE optimization context) instead.
In addition, according to some other example embodiments, there is provided, for example, a computer program product for a wireless communication device comprising at least one processor, including software code portions for performing the respective steps disclosed in the present disclosure, when said product is run on the device. The computer program product may include a computer-readable medium on which said software code portions are stored. Furthermore, the computer program product may be directly loadable into the internal memory of the computer and/or transmittable via a network by means of at least one of upload, download and push procedures.

While some example embodiments will be described herein with particular reference to the above application, it will be appreciated that the present disclosure is not limited to such a field of use, and is applicable in broader contexts.

Notably, it is understood that methods according to the present disclosure relate to methods of operating the apparatuses according to the above example embodiments and variations thereof, and that respective statements made with regard to the apparatuses likewise apply to the corresponding methods, and vice versa, such that similar description may be omitted for the sake of conciseness. In addition, the above aspects may be combined in many ways, even if not explicitly disclosed. The skilled person will understand that these combinations of aspects and features/steps are possible unless it creates a contradiction which is explicitly excluded.

Implementations of the disclosed apparatuses may include using, but not limited to, one or more processor, one or more application specific integrated circuit (ASIC) and/or one or more field programmable gate array (FPGA). Implementations of the apparatus may also include using other conventional and/or customized hardware such as software programmable processors, such as graphics processing unit (GPU) processors.

It is to be understood that any of the above-mentioned modifications can be applied singly or in combination to the respective aspects to which they refer, unless explicitly stated as excluding alternatives.

According to the disclosure it is therefore possible to overcome the issue of context loss by enabling storage of information, at least related to UEs (particularly essential information for at least enabling entity specific AI/ML model outputs or, generally, inter-node-based RAN actions), beyond the duration where the UE is originally identifiable in the RAN. Further, it is possible to retrieve of said information from neighbor nodes beyond the duration where the UE is identifiable in the RAN (and particularly at the source node) so that respective feedback and AI/ML procedures can be efficiently initiated.

### BRIEF DESCRIPTION OF THE DRAWINGS

Further details, features, objects and advantages are apparent from the following detailed description of the preferred embodiments of the present disclosure which is to be taken in conjunction with the appended drawings, wherein:

FIG. 1 shows a context activation initiation process between a source network entity and a target network entity;

FIG. 2 shows a message exchange for initiating a feedback message between a source network entity and a target network entity;

FIG. 3A shows a message exchange to implement UE context survival in a general feedback-based action between a source network entity and a target network entity;

FIG. 3B shows a message exchange to implement UE context survival in AI ML processes between a first NG-RAN node and second NG-RAN node;

FIG. 4 shows a message exchange to implement UE context survival in AI ML processes between a first NG-RAN node and an OAM.

### DESCRIPTION OF EXAMPLE EMBODIMENTS

In the following, different exemplifying embodiments will be described using, as an example of a communication network to which examples of embodiments may be applied, a communication network architecture based on 3GPP standards for a communication network, such as a 5G/NR, without restricting the embodiments to such an architecture, however. It is apparent for a person skilled in the art that the embodiments may also be applied to other kinds of communication networks where mobile communication principles are integrated with a D2D (device-to-device) or V2X (vehicle to everything) configuration, such as SL (side link), e.g. Wi-Fi, worldwide interoperability for microwave access (WiMAX), Bluetooth®, personal communications services (PCS), ZigBee®, wideband code division multiple access (WCDMA), systems using ultra-wideband (UWB) technology, mobile ad-hoc networks (MANETs), wired access, etc. Furthermore, without loss of generality, the description of some examples of embodiments is related to a mobile communication network, but principles of the disclosure can be extended and applied to any other type of communication network, such as a wired communication network.

The following examples and embodiments are to be understood only as illustrative examples. Although the specification may refer to “an”, “one”, or “some” example(s) or embodiment(s) in several locations, this does not necessarily mean that each such reference is related to the same example(s) or embodiment(s), or that the feature only applies to a single example or embodiment. Single features of different embodiments may also be combined to provide other embodiments. Furthermore, terms like “comprising” and “including” should be understood as not limiting the described embodiments to consist of only those features that have been mentioned; such examples and embodiments may also contain features, structures, units, modules, etc., that have not been specifically mentioned.

A basic system architecture of a (tele)communication network including a mobile communication system where some examples of embodiments are applicable may include an architecture of one or more communication networks including wireless access network subsystem(s) and core network(s). Such an architecture may include one or more communication network control elements or functions, access network elements, radio access network (RAN) elements, access service network gateways or base transceiver stations, such as a base station (BS), an access point (AP), a NodeB (NB), an eNB or a gNB, a distributed unit (DU) or a centralized/central unit (CU), which controls a respective coverage area or cell(s) and with which one or more communication stations such as communication elements or functions, like user devices or terminal devices, like a user equipment (UE), or another device having a similar function, such as a modem chipset, a chip, a module etc., which can also be part of a station, an element, a function or an application capable of conducting a communication, such as a UE, an element or function usable in a machine-to-machine communication architecture, or attached as a separate element to such an element, function or application capable of conducting a communication, or the like, are capable to communicate via one or more channels via one or more communication beams for transmitting several types of data in a plurality of access domains. Furthermore, core network elements or network functions, such as gateway network elements/functions, mobility management entities, a mobile switching center, servers, databases and the like may be included.

The following description may provide further details of alternatives, modifications and variances:
a gNB comprises e.g., a node providing NR user plane and control plane protocol terminations towards the UE, and connected via the NG interface to the 5GC, e.g., according to 3GPP TS 38.300 V16.6.0 (2021 June) section 3.2 incorporated by reference. Moreover, the following description and the proposed features of the present disclosure are not limited to be applied to the indicated framework but may also be applicable to other generations such as Long Term Evolution (LTE) technology and eNBs or other technologies such as LTE-Advanced (LTE-A) technology.
A user equipment (UE) may include a wireless or mobile device, an apparatus with a radio interface to interact with a RAN (Radio Access Network), a smartphone, an in-vehicle apparatus, an IoT device, a M2M device, or else. Such UE or apparatus may comprise: at least one processor; and at least one memory including computer program code; wherein the at least one memory and the computer program code are configured to, with the at least one processor, cause the apparatus at least to perform certain operations, like e.g. RRC connection to the RAN. A UE is e.g., configured to generate a message (e.g., including a cell ID) to be transmitted via radio towards a RAN (e.g., to reach and communicate with a serving cell). A UE may generate and transmit and receive RRC messages containing one or more RRC PDUs (Packet Data Units).
Further, a handover may be defined as a connection switch of a UE from a predetermined source network entity, preferably a source NG-RAN node, to a target network entity, preferably a target NR-RAN node. At it, handover may be available with or without control plane connection between source and target network entity.

The UE may have different states (e.g., according to 3GPP TS 38.331 V16.5.0 (2021 June) sections 42.1 and 4.4, incorporated by reference).

A UE is e.g., either in RRC_CONNECTED state or in RRC_INACTIVE state when an RRC connection has been established.

### RRC_CONNECTED State a Ue May:

store the AS context;
transfer unicast data to/from the UE;
monitor control channels associated with the shared data channel to determine if data is scheduled for the data channel;
provide channel quality and feedback information;
perform neighboring cell measurements and measurement reporting.

The RRC protocol includes e.g. the following main functions:
RRC connection control;
measurement configuration and reporting;
establishment/modification/release of measurement configuration (e.g. intra-frequency, inter-frequency and inter-RAT measurements);
setup and release of measurement gaps;
measurement reporting.

The general functions and interconnections of the described elements and functions, which also depend on the actual network type, are known to those skilled in the art and described in corresponding specifications, so that a detailed description thereof may omitted herein for the sake of conciseness. However, it is to be noted that several additional network elements and signaling links may be employed for a communication to or from an element, function or application, like a communication endpoint, a communication network control element, such as a server, a gateway, a radio network controller, and other elements of the same or other communication networks besides those described in detail herein below.

A communication network architecture as being considered in examples of embodiments may also be able to communicate with other networks, such as a public switched telephone network or the Internet. The communication network may also be able to support the usage of cloud services for virtual network elements or functions thereof, wherein it is to be noted that the virtual network part of the telecommunication network can also be provided by non-cloud resources, e.g. an internal network or the like. It should be appreciated that network elements of an access system, of a core network etc., and/or respective functionalities may be implemented by using any node, host, server, access node or entity etc. being suitable for such a usage. Generally, a network function can be implemented either as a network element on a dedicated hardware, as a software instance running on a dedicated hardware, or as a virtualized function instantiated on an appropriate platform, e.g., a cloud infrastructure.

Furthermore, a network element, such as communication elements, like a UE, a terminal device, control elements or functions, such as access network elements, like a base station/BS, a gNB, a radio network controller, a core network control element or function, such as a gateway element, or other network elements or functions, as described herein, and any other elements, functions or applications may be implemented by software, e.g., by a computer program product for a computer, and/or by hardware. For executing their respective processing, correspondingly used devices, nodes, functions or network elements may include several means, modules, units, components, etc. (not shown) which are required for control, processing and/or communication/signaling functionality. Such means, modules, units and components may include, for example, one or more processors or processor units including one or more processing portions for executing instructions and/or programs and/or for processing data, storage or memory units or means for storing instructions, programs and/or data, for serving as a work area of the processor or processing portion and the like (e.g. ROM, RAM, EEPROM, and the like), input or interface means for inputting data and instructions by software (e.g. floppy disc, CD-ROM, EEPROM, and the like), a user interface for providing monitor and manipulation possibilities to a user (e.g. a screen, a keyboard and the like), other interface or means for establishing links and/or connections under the control of the processor unit or portion (e.g. wired and wireless interface means, radio interface means including e.g. an antenna unit or the like, means for forming a radio communication part etc.) and the like, wherein respective means forming an interface, such as a radio communication part, can be also located on a remote site (e.g. a radio head or a radio station etc.). It is to be noted that in the present specification processing portions should not be only considered to represent physical portions of one or more processors, but may also be considered as a logical division of the referred processing tasks performed by one or more processors. It should be appreciated that according to some examples, a so-called “liquid” or flexible network concept may be employed where the operations and functionalities of a network element, a network function, or of another entity of the network, may be performed in different entities or functions, such as in a node, host or server, in a flexible manner. In other words, a “division of labor” between involved network elements, functions or entities may vary case by case.

Further, when speaking of a AI/ML model in a RAN, a ML model may be executed and/or trained at at least a RAN network entity such as at a NG-RAN node side or a OAM side. Herein, the aforementioned network entities may have one or more trained or to be trained models available and the models are preferable configured to solve a certain predetermined problem, preferably an optimization problem. Additionally, a given network entity may also have a non-ML algorithm implemented internally (e.g. native in the network entity). Accordingly, the respective network may be able to instruct the network entity for which model the network entity should use at any given time and when to activate this model.

On the other hand, the network entity may also be able to indicate to other network entities or generally to the network whether it is an ML capable network entity. In addition, even if a UE has indicated to the network or to other network entities that it is ML capable, it is possible that the network entity becomes unable to perform ML in the course of time if it detects for example that the network connectivity is changed or when the power of the network entity has dropped under a certain threshold, to name a few examples. Thus, a network entity may be able to dynamically indicate its current ML ability within the network and the network may also dynamically choose other network entities to implement a ML model on.

Accordingly, since RAN is a distributed architecture, a given network entity an ML model is implemented on may be required to request and obtain necessary information such as measurement and/or training data from other network entities. Herein, such inter-node procedures may be for example generated by a resource status procedure between the model possessing network entity and a second network entity.

On the other hand, since specifically UE contexts are generally lost after UE handover, current ML model implementations (yet also non-ML model implementations) in RAN may suffer from severe efficiency decreases due to the fact that subsequent feedback or follow-up processes (i.e. implementation of model outputs) may not be redirected to the UEs they originally responded to. For example, one method for receiving neighboring node information is utilizing the resource status procedure. However, resource status information involves node-based reporting and does not include any further specifications pertaining e.g. the single UEs the requested data is gained from, leading to the fact that in current RAN architecture signaling, there is no method to collect UE (or UE group) specific information from neighbor nodes, not to mention to store this information for use after the UE context has been released. As a result, a target gNB upon receiving a Handover Request is per current standard not made aware that during the Handover procedure, it needs to collect specific data for performance feedback. The Cause Information Element (IE) in the aforementioned Handover Request can indicate the cause value of the handover (e.g. Reduce Load in Serving Cell, Resource Optimization, UE power saving etc.), but it cannot give the target node a mechanism to identify specific data collection needs to perform a respective action, such as a performance feedback Note that performance feedback (also called feedback for brevity) can be used for monitoring the performance of the AI/ML Model when available.

Accordingly, to avoid the abovementioned problem, it was proposed that specifically UE performance measurements should be additionally signaled from a target gNB after a Handover is completed. Yet, since soon after a handover is executed the UE context ceases to exist at the source gNB, the above-mentioned solution may allow only to provide performance information (of one or more UEs) until the time point of a respective UE context release, resulting in the effect that collection of potentially required feedback information (e.g., with respect to a throughput or a delay metric that are averaged over a predefined (typically (much) larger than the UE context survival time) period of time after a Handover is completed at the target gNB) may be prohibited.

Hence, according to some example embodiments, a new UE ML context may be initiated at least between a number of network entities, preferable at least between NG-RAN nodes or OAM, of the respective RAN, before feedback pertaining to respective UEs of the RAN action (handover) is requested. Herein, feedback may correspond to measurement, counters or information to evaluate the performance of a given RAN action.

In some example embodiments, for this a UE ML group index may be generated to identify the new UE ML context and to allow a gNB to trace UEs beyond a point of initial context release. Herein, a given group index may respectively correspond and identify to a predetermined set of UEs (a so called UE ML group) defined by a characteristic criterion, being for example a characteristic mobility path or trajectory, radio capabilities, activated service, radio conditions or impacts on predefined network actions, leading to the effect that by allocating said group index into at least one or more network entities within the given RAN, UE ML contexts can be reinitiated even after the initial context (i.e. after a handover process) is lost.

Accordingly, in said example embodiments, a process step of new content initiation may be implemented in the respective RAN process (e.g. a AI ML process) by allocating and transferring said UE ML group index in and between network entities (i.e. between a source network entity and a target network entity) of the corresponding RAN, wherein the new context initiation may be an asynchronous message that can be initiated and terminated at every stage of the process and can be used to associate measurements and other information to a UE ML context.

As a consequence, in some example embodiments, the new context initiation may be sent:
before at least one of a feedback, measurement, counter, information gain pertaining to the UEs of the RAN baseline action or an action produced as an outcome of AI/ML Model Inference e.g. a handover, energy saving decisions, load balancing etc.) is requested; or
before a network entity trains a model or implements respective measurement data into a predetermined application so to allow the aforementioned network entity to receive specific information/measurement for training/implementation purposes.

Further, in additional embodiments of the disclosure, a given network entity may further configure a target network entity to indicate during new context initiation at least which information (measurements, counters etc.) it requires to be informed about (Preferably, it is the node starting the ML Context initiation that configures which measurements it wants to receive from a neighbour). Exemplarily, such information may be an average throughput or delay measurements of a predetermined UE in a UE ML group. Additionally, in case measurements involve averages, the network entity may also configure a starting time during which the measurements need to be started at the target network entity and an ending time when the measurements need to be stopped at the target network entity. As an alternative, the network entity may configure the target network entity with a starting time and an average window over which the average is calculated. Optionally, also the starting time informing when a measurement needs to be conducted may be indicated through a starting event (e.g. when a first UE in the UE ML group is handed over). Optionally, also the ending time informing when a measurement needs to be stopped may be indicated through an ending event at the node conducting the measurements (e.g., if one or more UEs participating the UE ML group are subsequently handed over to another node).

In additional embodiments, in order to collect and coordinate a gained feedback, a given network entity may be also configured to send respective feedback in terms of an additional RAN action reports, in case of a utilized AI ML model for example as an AI ML report. To additionally ensure permanent UE ML context, said RAN action report may be preferably tagged by the UE ML group index, leading to the effect that the respective requesting network entity is hereby informed which UEs the measurements in the report is referring to. In further embodiments, the UE ML group index also may include information about a respective network action, e.g., the AI ML algorithm that created the UE ML group index, so that corresponding usage of the new context initiation can be efficiently backtracked.

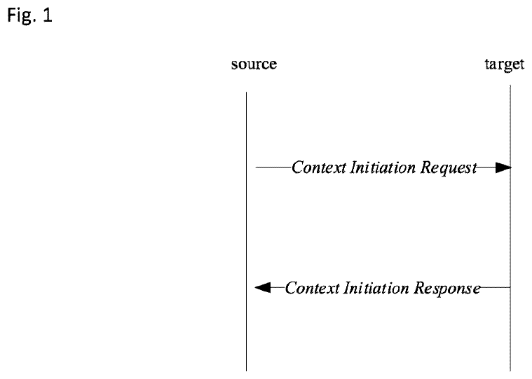

Accordingly, FIG. 1 shows a first exemplary embodiment of a new context initiation process between a source network entity (source) and a (one or more) target network entity (target). It is to be noted that also a plurality of target network entities may be used. As stated, the respective network entities may be at least a NG-RAN node or an OAM of a corresponding RAN, but the network entities are not limited to these elements. Accordingly, the source and the target network entity may be equally part of a superordinate apparatus in RAN, wherein the source network entity may be part of a first apparatus and the target network entity may be part of a second apparatus. Equally, at least one of both, the first or the second apparatus or the target or source network may comprise means for monitoring, means for supervising, means for instructing and/or means for requesting needed information or data, leading to the effect that the respective apparatus or network entities may be configured to independently conduct and perform working processes imposed by the RAN. Herein, the means for monitoring, means for supervising, means for instructing or means for requesting may be monitoring means, supervising means, instructing means or requesting means, respectively. The means for monitoring, means for supervising, means for instructing and means for requesting may be a monitor supervisor, an instructor and a requester, respectively. Optionally, the means for monitoring, means for supervising, means for instructing or means for requesting may be also a monitoring processor, supervising processor, instructing processor or a requesting processor, respectively.

Accordingly, in the exemplary embodiment, when new context initiation process shown in FIG. 1 is conducted between the source network entity and the target network entity (or a plurality of target network entities), initially, a Context Initiation Request (more preferably a ML Context Initiation Request) may be sent from the source network entity to one or more target network entities. The Context Initiation Request hereby may contain initiation information such as for example at least a sought UE ML group index and/or a predefined measurement configuration indicating the requested target network entity which of its stored information or measurement data are needed by the source network entity and how these should be collected for example through indication of timing information (e.g., starting time/event, ending time/event, or an averaging window). Further, the target network entity receiving the Context Initiation Request may respond with sending back a Context Initiation Response (more preferably a ML Context Initiation Response), being at least a message acknowledging (or rejecting) the previous request of the source network entity.

Optionally, instead or in addition to the above-mentioned embodiment, a Context Initiation Request yet do not need to be processed independently. Instead, in other exemplary embodiments, a Context Initiation Request may be equally piggybacked in other RAN actions such as for example a Handover Preparation procedure, through which the source network entity may request a target network entity to collect additional data for the UE participating in the RAN action in a UE-associated manner. For this, the source network entity may also include indicating, in the given RAN action, that a UE ML Context will survive after an initial UE Context Release is sent from the target network entity to the source network entity (by receiving the new UE MLcontext via UE ML group index collection), leading to the effect that for particular UEs more data can be subsequently sent between the source and the target network entity without risking to lose a given UE ML context. Equally, the source network entity may additionally indicate to the target network entity the data collection configuration that should be enabled at the target network entity after the given handover is completed for the UE.

In some examples, the above-mentioned functions and process steps of the new context initiation process may be applicable for the Xn interface (in case of Xn complete handover (HO)). In other examples, such may be yet also applicable for the NG interface, e.g., by means of handover signaling via the Core Network (CN) in case of NG handover.

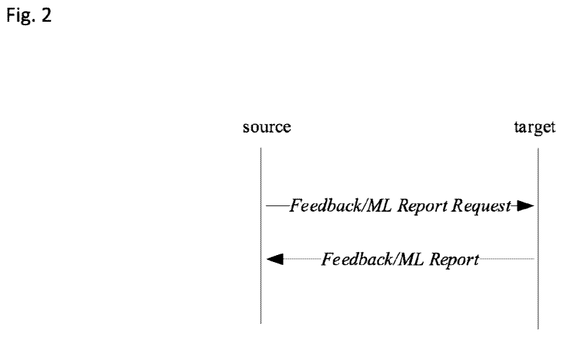

Further, the actual measurements of the given RAN action may be equally sent in feedback (or, in case of an AI ML model implementation, in a ML Report) message, preferably when said measurement data is progressively collected. Herein, FIG. 2 shows an exemplary embodiment of such a process.

For this, comparative to the process shown in FIG. 1, a respective source network entity may initially request a given Feedback Report by sending a Feedback Report Request to a predetermined target network entity. The Feedback Report Request may include as an argument the UE ML group information (e.g., index) for which feedback is requested. As a consequence, said target network entity may respond to the aforementioned Feedback Report Request and send the request measurement data in a Feedback Report back to the source network entity. Accordingly, since the above-mentioned process steps may be conducted by additionally taking into account a predetermined UE ML group index (hence securing the UE ML context during the entire process), an efficient and UE specific data request can be generated. Operations on UE ML groups can be collectively created, modified and deleted, therefore considering in an efficient manner all UEs of said UE ML group. Modifications of UE ML groups may include adding or deleting required measurements for the UEs of said group. Accordingly, a modification addressing the UE ML group may affect all UEs of said group. Using the UE ML group index a neighboring node can identify and receive measurement information about the respective UEs, even after the context is expired.

Additionally, in further examples, feedback may be sent particularly upon request or when an RAN Action Report (e.g., a ML Report) is available at a network entity such as a NG-RAN node. Optionally, feedback messages may be also sent at a predefined time, particularly in a prospective time window or time point.

Further, it is again to be noted that the aforementioned new context initiation process may be processed for any given action, preferably optimization actions, in RAN which may be required to rely on feedback or other network processes that needs to outlast an initial UE ML context release (e.g., after a handover). Accordingly, even though the described embodiments may be for example implemented for AI ML optimization cases, such as the use of AI ML models for mobility optimization, energy saving or load balancing in RAN to mention a few examples, the respective new context initiation processes may not be limited to such RAN actions alone, but can be used for any given RAN action that may require prolonged UE context.

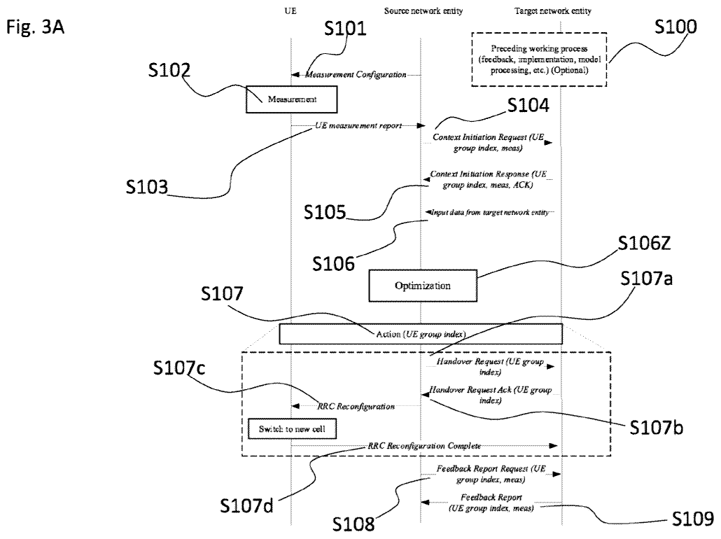

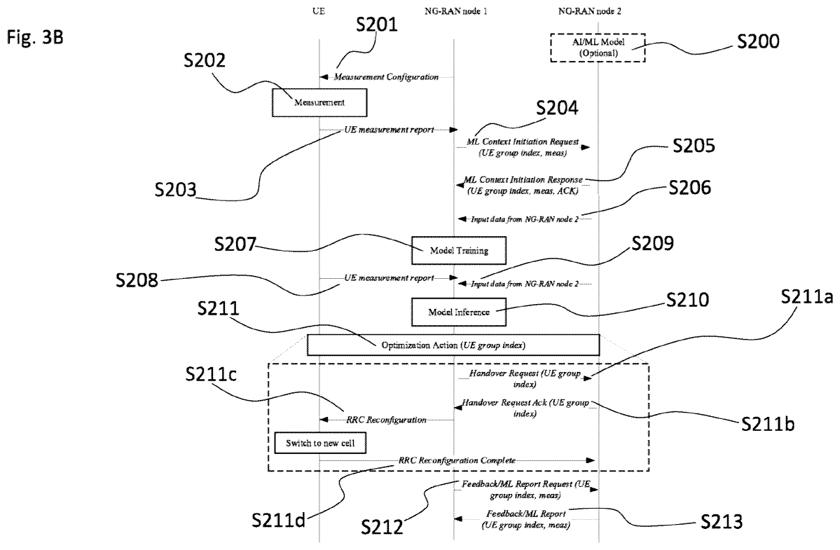

On that account, FIG. 3A shows an exemplary message exchange to implement UE context (UE ML context or UE optimization context) survival in a general feedback-based action between a source network entity and a target network entity based on a first embodiment of the disclosure. Herein, in step S100, a given target network entity may initially conduct a preceding, preferably optional working process, such as an additional feedback implementation, an AI ML model processing or any other procedure in RAN which may generate required input such as resource status and/or utilization predictions/estimations. In preferable embodiments, such working process may be also the initiation of a next iteration loop generated by implementing the feedback/output data of the respective RAN action generated in a last iteration step back to the respective network entity. Accordingly, the subsequently described process may be also understood as an iterative process or optimization loop that may be processed for a predefined amount of times or until a given threshold amount may be reached.

In step S101, consecutively, the source network entity may configure the measurement information on the UE side and sends a configuration message to a corresponding UE including configuration information for instructing the UE to collect requested and UE specific information data (e.g., performance data). At it, the number of connected UEs is not limited. Equally, the respective source network entity may be configured to send a configuration message not only to one but several UEs.

In step S102, the respective UE then may collect the indicated information data by UE related measurements. Herein, UE measurements may for example relate to RSRP, RSRQ, SINR or serving cells and/or neighboring cells.

Thereupon, in step S103, the UE may send a measurement report message back to the source network entity including the requested measurements/information data.

As a response, in step S104, the source network entity may initiate then a UE Context for data that potentially is to be used for a given action in RAN by sending a Context Initiation Request to a target network entity as previously described in FIG. 1. Herein, the Context Initiation Request may include an ID identifying a UE group identified by a predetermined UE group index so as to subsequently relate the used measurement data with the UEs used for measurement extraction. Additionally, the ID may be used to indicate the measurement data to be implemented for the respective action (e.g., an integrated application process) in RAN or at the respective source network entity. These measurements then may need to be collected by the target network entity the Context Initiation Request is send to. A measurement configuration may also be given along to identify requested measurements and how those measurements should be collected for example through indication of timing information (e.g., starting time/event, ending time/event, or an averaging window).

Further, in step S105, the respective target network entity then may respond with a message acknowledging the UE Context Initiation for the requested measurements.

In step S106, the source network entity then may obtain the input data to be implemented for the respective RAN action from the target network entity, wherein the respective input data may include at least the required input information from the target network entity. Herein, if the respective target network entity equally executes a preceding initiation process of the RAN action (e.g., a model training of a given AI ML model), the input data may also include the output data, such as inference results from the target network entity. Furthermore, input data received from the target network entity may be equally associated with the initiated UE Context ID.

In optional step S106Z an optimization process is conducted. The optimization is conducted to optimize the handover process wherein the optimization uses preferably an optimization algorithm. The optimization algorithm may be modified based on feedback information received from the target network entity with e.g., the context initiation response and/or the feedback report. Since said feedback report information may comprise information on UEs affected by the optimization, the UEs assigned to a UE group or UE ML group, the algorithm can be further improved by being modified taking the feedback information into account. The feedback information may be available for the source network entity at least some time after the actual handover is over, so that also the identification of the UE remains possible at least for said time, at least due to the assigned UE group or UE ML group and the related index. In a further example the optimization algorithm may be an AI/ML algorithm or model.

Then, in step S107, according to the received input data and/or measurements, at least one of the respective UEs, the source network entity or the target network entity may carry out the corresponding RAN action including the integrated handover procedure (switch to new cell) to hand over UE from at least the source network entity to the target entity. In one option, the RAN action may be for this parametrized by the UE context ID, leading to the effect that e.g., the target network entity may be informed that information according to the measurements indicated in the UE Context is required for a given UE. So, the target entity in this way knows that it should calculate (average) performance information (e.g., throughput, delay, QoS, etc.) including the UE participating the handover. If the UE context ID is not included in the RAN action then the UE participating the handover may not be used for calculation of the (average) performance information. As an example, the RAN action may comprise, a signaling process between at least the source and the target network entity providing a Handover Request (step S107a) between the source and the target network entity as well as a handover acknowledgement (Ack) signal (S107b). Equally, to avoid configuration errors between the network entities and the respective UEs, Radio Resource Control (RRC) Reconfiguration may take place by providing respective reconfiguration protocols from at least one of the source or target network entity to the respective UE (step S107c). As a consequence, RRC Reconfiguration may be acknowledged as completed after a given handover (step S107d).

Finally, upon completion of the RAN action and thus the respective handover, the source network entity may request, in step S108, from the target network resource feedback information related to a UE Context ID as described in FIG. 2.

As a consequence, in step S109, the target network entity may send the requested feedback information associated to the UE Context to the source network entity so that the source network entity, even after the handover is completed, is still able to identify the respective UEs of the predefined UE ML group. Accordingly, with the given information, the respective source network entity may for example implement the output of the RAN action (e.g., such of an AI ML model) or the respective feedback to additional network entities or UEs for additional optimization processes. Also, as already stated above, generated feedback information may be for example reinstated into the RAN, specifically into the respective source or target network entities so as to generate an iterative optimization loop starting again at step S100 of the shown context surviving process of FIG. 3A. Preferably the feedback information is related to a UE ML Context ID.

Furthermore, FIG. 3B shows an additional embodiment of context surviving process of FIG. 3B in which the respective RAN action may be explicitly constructed as an AI ML optimization process, such as a mobility optimization process, an energy saving or load balancing process to name a few examples integrated in a NG-RAN node.

Accordingly, in comparison to the rather general process shown in FIG. 3A, the respective source and target network entities may be defined as predetermined NG-RAN nodes, respectively NG-RAN node 1 and 2, between which a corresponding handover may be proceeded.

Further, as a consequence of AI ML model procedures, prior to the actual optimization action (herein shown in step S211) including the respective handover process, a step of Model Training (FIG. 3B, step S207) and Model Inference (FIG. 3B, step S210) may be added to the AI ML optimization process so as to efficiently generate respective optimization solutions in RAN.

As a consequence, the input data gained previously in step S206 at the source network entity (now NG-RAN node 1) from the target network entity (NG-RAN node 2) may be equally used for training of the respective AI ML model, wherein the input data for training may equally include the required input information from the NG-RAN node 2. Optionally, if the NG-RAN node 2 would execute the AI ML model, the input data for training may likewise include the corresponding inference result from the NG-RAN node 2. Also, input data received from NG-RAN node 2 may be associated with the initiated UE Context ID.

Consecutively, in said step S207 of FIG. 3B, model training may be initiated. Herein the required measurements may be leveraged to the respective AI ML model for a predefined optimization reason such as the aforementioned mobility optimization, energy saving or load balancing optimization.

Further, in step S208 of FIG. 3B, after model training is completed, the respective NG-RAN node 1 may also obtain a measurement report as additional inference data for real-time optimization, leading to an even more efficient optimization process.

Equally, in step S209 of FIG. 3B, the NG-RAN node 1 may obtain input data for model inference from the NG-RAN node 2 for optimization, where the input data for inference may include the required input information from the NG-RAN node 2. Herein, likewise, if the NG-RAN node 2 may execute the AI ML model, the input data for inference can also include the corresponding inference result from NG-RAN node 2. Input data for inference may also be associated to the same UE ML Context initiated for ML Training. In one option, UE ML Context can be initiated before Inference data is received from NG-RAN node 2 to associate only Inference data of UE ML Context. For example, in the aforementioned case, UE ML Context may refer to only UEs that are impacted by an inference action.

As a consequence, after collecting the required input data in step S208 and S209, model inference may take place subsequently in step S210 of FIG. 3B. Herein, required measurements may be equally leveraged into the model inference so as to output a respective prediction, including e.g., UE trajectory prediction, target cell prediction, target NG-RAN node prediction, etc.

In addition, according to these predictions, recommended actions or configurations, the NG-RAN node 1, the NG-RAN node 2 and the respective UE may again perform the respective AI ML based optimization/handover procedure to hand over UE from NG-RAN node 1 to the target NG-RAN node 2. Equally, in one option the optimization may be parametrized by the UE Context ID.

Further, steps S211a to S213 may be analogue to the handover and feedback processing steps described under steps S107a-S109 of FIG. 3A, respectively.

Accordingly, as can be seen by the above-mentioned optimization process of FIG. 3B, the respective context surviving process claimed in the present disclosure may be implemented for a broad variety of different AI ML and non-AI ML optimization processing, preferably for such, in which specifically UE ML contexts are remaining important even after a given handover process. On that account, it is again to be noted that the configuration of the claimed process is not limited to any of the embodiments for example shown in the FIGS. 1 to 3B but equally can be varied in single or several process steps or apparatus conditions.

For example, in a preferred embodiment of the disclosure, AI ML model training do not need to be conducted in the same network entity as the subsequent model inference. In contrast, model training may be processed for example in a target network entity (e.g., NG-RAN node 2 shown in FIG. 3B) while model inference is processed in the source network entity (e.g., NG-RAN node 1) or vice versa. In other preferred embodiments, any of the aforementioned process steps may be also conducted in other network entities of a respective RAN, for example the OAM so that, exemplarily, model training may be conducted in the OAM while by means of output signaling, the gained output data may be further transferred for model inference to other network entities such as NG-RAN node 1. In a further example of the disclosure according to FIG. 3B, the RAN node 2 may be replaced by an OAM so that requests may be equally exchanged between a respective NG-RAN source node (NG-RAN node 1) and an OAM of the respective RAN.

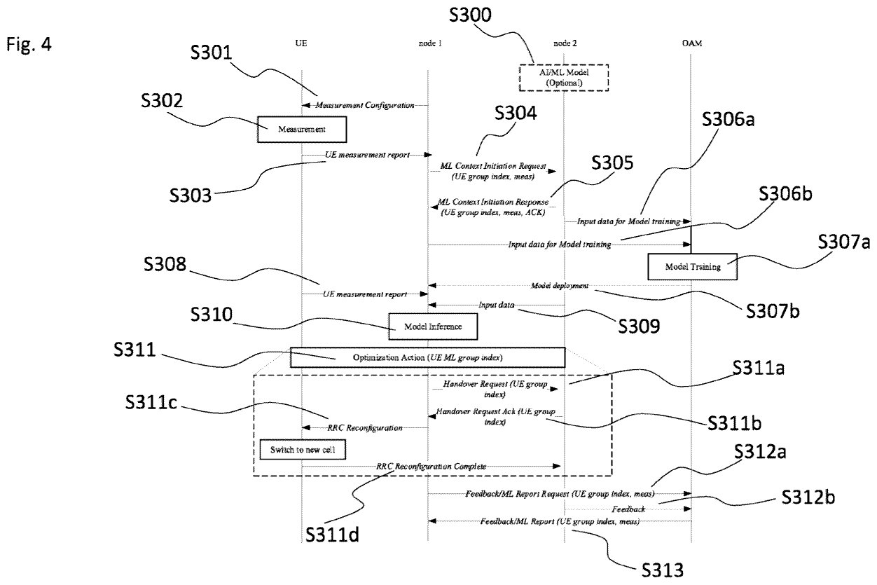

Accordingly, as a further embodiment of the disclosure, FIG. 4 may equally show a message exchange to implement UE ML context survival in a general feedback-based action wherein, compared to the signaling procedure between the NG-RAN node 1 and NG-RAN node 2 of FIG. 3B, respective context initiation, handover and feedback reports and/or requests may be equally conducted between a respective NG-RAN source node (NG-RAN node 1) and an OAM of the respective RAN. At it, it is deemed that the construction of corresponding signaling pathways between a NG-RAN source node and an OAM can be derived from said disclosure in FIG. 4. The NG-RAN node 2 is assumed to optionally have an AI/ML model, which can generate required input such as resource status and utilization prediction/estimation etc. In Step 301. NG-RAN node1 configures the measurement information on the UE side and sends configuration message to UE including configuration information. In Step S302. UE collects the indicated measurement, e.g., UE measurements related to RSRP, RSRQ, SINR of serving cell and neighboring cells. Moreover, in step 303. UE sends measurement report message to NG-RAN node1 including the required measurement.

In step S304 the initiation request is provided to the target network entity, for inter-node signaling managing the UE ML context. The NG-RAN node 1 initiates a UE ML Context for data that will be used for training an AI/ML algorithm. NG-RAN node 1 may include an ID identifying the UE ML group and further indicates the measurements needed for training of an AI/ML Model. Those measurements need to be collected by the OAM, for example by separate signaling when the request S304 is directly signaled to the OAM or via the NG-RAN node 2 and the input data in step S306a as in the example in FIG. 4. A measurement configuration is given along to identify the requested measurements. The signaling, may further include a configuration information which comprises a configuration over the needed measurements/counters/predictions and how those measurements should be collected (preferably this may include an averaging window to calculate a measurement if a measurement is based on an average namely a starting and ending time or event or just a starting time/event and duration of the averaging window, an accuracy condition that needs to be met if a prediction is expected and its validity time, measurement triggering conditions (event-based or time-based). Measurements may comprise also inference from a gNB or from a UE when AI/ML decisions are taken. Measurement may comprise performance information on UE-level (e.g., bit-rate, packet loss, latency, energy efficiency, etc.) over UEs impacted by an inference action e.g., UEs for which a Handover is triggered due to an AI/ML mobility optimization decision or UEs that are connected to a capacity cell deciding to switch off for energy saving purposes. Measurement may comprise performance information at cell-level after an inference action is taken e.g., based on a number of system KPIs (throughput, delay, RLF, etc.), counters. In step S305 the NG-RAN node 2 responds with a message acknowledging the UE ML Context initiation for the requested measurements.

Accordingly, a signaling-based approach is suggested where a “UE ML group” set in advance, may correspond to a set of UEs receiving similar handling in the RAN due to e.g., UE history or following a similar mobility path or trajectory, radio capabilities, activated services or slices, radio conditions, UEs impacted by a network action (e.g., by a SON or AI/ML algorithm output or some other network decision), etc. The UE ML group is identified by its UE ML group index. Allocation of the UE ML group may be, for instance, corresponding to a) all UEs that the network has selected for training of an ML model or algorithm such as AI/ML Energy Saving, Mobility Optimization or Load Balancing to name a few examples, b) all UEs that the network has selected for running inference of an ML algorithm, etc. Each NG-RAN node will locally store information about its UE ML groups in a newly introduced context, the “UE ML context”. UEs belonging in a UE ML group will be used by the network to calculate counters or performance measurements only according to the UE ML context.

In step S306a and S306b, OAM obtains the input data for training of the AI/ML model from the NG-RAN nodes, where the input data for training includes the required input information from the nodes. If one of the nodes executes the AI/ML model, the input data for training can include the corresponding inference result from the respective node. Input data received from nodes may be associated with the initiated UE ML Context ID. In step S307a the training of the AI/ML model or algorithm is performed. In step S307b the AI/ML model is deployed to the selected node, which is NG RAN node 1 in FIG. 4.

In step S308 NG-RAN node1 obtains the measurement report as inference data for real-time UE optimization such as mobility optimization. Subsequently, in step S309 the NG-RAN node 1 obtains the input data for inference from the NG-RAN node 2 for UE optimization, where the input data for inference includes the required input information from the NG-RAN node 2. If the NG-RAN node 2 executes the AI/ML model, the input data for inference can include the corresponding inference result from the NG-RAN node 2. Input data for inference may also be associated to the same UE ML context initiated for ML Training. In one option, UE ML context can be initiated before inference data is received from NG-RAN node 2 to associate only inference data to the UE ML context. For example, in this case UE ML context refers to only UEs that are impacted by an inference action. Model inference is performed in step S310. Required measurements are leveraged into model inference to output the prediction, including e.g., UE trajectory prediction, target cell prediction, target NG-RAN node prediction.

Further, steps S311a to S313 may be analogue to the handover and feedback processing steps described under steps S107a-S109 of FIG. 3A, respectively. According to the prediction, recommended actions or configuration, the NG-RAN node 1, the target NG-RAN node (exemplarily represented by NG-RAN node 2), and UE perform the optimization action/handover procedure to hand over UE from NG-RAN node 1 to the target NG-RAN node. In one option an optimization action can be parameterized by the UE ML context ID. This can inform the target gNB that performance information according to the measurements indicated in the UE ML context is required to be calculated for a given UE.

The measurements provided with the ML report in step S308 and/or S313, may comprise performance information on UE-level (e.g., bit-rate, packet loss, latency, energy efficiency etc.) over UEs impacted by an inference action e.g., UEs for which a handover is triggered due to an AI/ML mobility optimization decision or UEs that are connected to a capacity cell deciding to switch off for energy saving purposes as an example.

Based on these features storage of information related to UEs beyond a duration where the UE is identifiable in the RAN, is achieved and processing of feedback information (related to a UE ML Context ID) and corresponding configuration by the network regarding the amount, the triggering conditions and the identity of those measurements is possible. Moreover, retrieval of UE related information from neighbor nodes, beyond the duration where the UE is identifiable in the RAN becomes possible, at least due to the UE ML group index.

Finally, it is nevertheless to be noted that, although in the above-illustrated example embodiments (with reference to the figures), the messages communicated/exchanged between the network components/elements may appear to have specific/explicit names, depending on various implementations (e.g., the underlining technologies), these messages may have different names and/or be communicated/exchanged in different forms/formats, as can be understood and appreciated by the skilled person.

Although reference is made to the UE ML group, UE ML group index and UE ML context, which may be characteristic for an AI/ML framework, in a further development, in case a non-AI/ML algorithm is used, there may be a UE group (or UE optimization group) a UE group index (or UE optimization group index) and a UE context (or UE optimization context) instead. According to some example embodiments, there are also provided corresponding methods suitable to be carried out by the apparatuses (network elements/components) as described above, such as the UE, the CU, the DU(s), etc.

It should also be noted that the apparatus (device) features described above correspond to respective method features that may however not be explicitly described, for reasons of conciseness. The disclosure of the present document is considered to extend also to such method features. In particular, the present disclosure is understood to relate to methods of operating the devices described above, and/or to providing and/or arranging respective elements of these devices.

Further, according to some further example embodiments, there is also provided a respective apparatus (e.g., implementing the UE, the CU, the DU, etc., as described above) that comprises at least one processing circuitry, and at least one memory for storing instructions to be executed by the processing circuitry, wherein the at least one memory and the instructions are configured to, with the at least one processing circuitry, cause the respective apparatus to at least perform the respective steps as described above.

Yet in some other example embodiments, there is provided a respective apparatus (e.g., implementing the UE, the CU, the DU, etc., as described above) that comprises respective means configured to at least perform the respective steps as described above.

It is to be noted that examples of embodiments of the disclosure are applicable to various different network configurations. In other words, the examples shown in the above-described figures, which are used as a basis for the above discussed examples, are only illustrative and do not limit the present disclosure in any way. That is, additional further existing and proposed new functionalities available in a corresponding operating environment may be used in connection with examples of embodiments of the disclosure based on the principles defined.

It should also be noted that the disclosed example embodiments can be implemented in many ways using hardware and/or software configurations. For example, the disclosed embodiments may be implemented using dedicated hardware and/or hardware in association with software executable thereon. The components and/or elements in the figures are examples only and do not limit the scope of use or functionality of any hardware, software in combination with hardware, firmware, embedded logic component, or a combination of two or more such components implementing particular embodiments of the present disclosure.

It should further be noted that the description and drawings merely illustrate the principles of the present disclosure. Those skilled in the art will be able to implement various arrangements that, although not explicitly described or shown herein, embody the principles of the present disclosure and are included within its spirit and scope. Furthermore, all examples and embodiment outlined in the present disclosure are principally intended expressly to be only for explanatory purposes to help the reader in understanding the principles of the proposed method. Furthermore, all statements herein providing principles, aspects, and embodiments of the present disclosure, as well as specific examples thereof, are intended to encompass equivalents thereof.

1. Apparatus comprising:
one or more processors and a memory storing instructions that, when executed by the one or more processors, cause the apparatus to:
submit, by a source network entity of a radio access network, RAN, a request to a target network entity, the request including at least a user equipment machine learning, UE ML, group index, wherein the UE ML group index at least indicates that a UE is part of a UE ML group;
receive, by the source network entity, a response message from the target network entity based at least on the indicated UE ML group index.

2. The apparatus according to claim 1, wherein the request includes an identifier, ID, for identifying a UE ML group and configuration information, indicating requested data to be collected by the target network entity at least for training or inference of a machine learning, ML, model.

3. The apparatus according to claim 1, wherein the apparatus is caused to at least train the ML model based on information of the received response message of the target network entity.

4. The apparatus according to claim 1, wherein the apparatus is caused to execute a UE handover procedure according to an optimization action based at least on information according to the received response message.

5. The apparatus according to claim 1, wherein the configuration information further includes at least one of an instruction on how the requested data should be collected or an instruction specifying timing information of the requested data;
wherein the requested data includes at least one of: requested measurements, requested counters, requested predictions.

6. The apparatus according to claim 1, wherein the requested measurements include inference information at least from a network node or a UE before or after ML actions are taken.

7. The apparatus according to claim 1, wherein the requested measurements include at least performance information on UE-level over a UE impacted by an inference action for which a handover is triggered due to an optimization decision or a UE that is connected to a capacity cell deciding to switch off.

8. The apparatus according to claim 1. wherein the response message is a feedback report provided after an ML model inference is executed, in a use case including a UE handover.

9. The apparatus according to claim 1, wherein the response message includes a UE ML group index and feedback information, the feedback information including information of UEs impacted by an ML inference.

10. The apparatus according to claim 9, wherein the feedback information includes at least information which is averaged over a period of time.

11. The apparatus according to claim 10, wherein the period of time includes at least a time after the UE handover is completed at the target network entity.

12. The apparatus according to claim 9, wherein feedback information is logged in a ML Report that accumulates the requested data from a neighboring network entity.

13. The apparatus according to claim 1, wherein the request to the target network entity requests information per UE ML group.

14. Apparatus comprising:
one or more processors and
a memory storing instructions that, when executed by the one or more processors, cause the apparatus to:
transmit, by a source network entity to a target network entity, a handover required message including a user equipment machine learning, UE ML, group index and an instruction that feedback information should be available after the handover is completed for the UE, or available after a context release message is sent from the target network entity to the source network entity.

15. Apparatus according to claim 14, wherein the apparatus is further caused to store the information of the handover required message at least until a release message is received at the source network entity.

16. The apparatus according to claim 14, wherein the apparatus is caused to receive, by the source network entity, a response message from the target network entity based at least on the indicated UE ML group index and including the feedback information; and
to execute a UE handover procedure according to an optimization action based at least on the feedback information of the received response message.

17-23. (canceled)

24. Method of a source network entity of a radio access network, RAN, the method comprising:
submitting a request to a target network entity, the request including at least a user equipment machine learning, UE ML, group index, wherein the UE ML group index indicates that a UE is part of a UE ML group;
receiving a response message from the target network entity based at least on the indicated UE ML group index.

25-29. (canceled)

30. The method according to claim 24, wherein the request includes an identifier, ID, for identifying a UE ML group and configuration information, indicating requested data to be collected by the target network entity at least for training or inference of a machine learning, ML, model.

31. The method according to claim 24, further comprising training the ML model based on information of the received response message of the target network entity.

32. The method according to claim 24, further comprising executing a UE handover procedure according to an optimization action based at least on information according to the received response message.
